(19) United States
(12) Patent Application Publication
(10) Pub. No.: US 2026/0318777 A1
(43) Pub. Date: Oct. 15, 2026

(54) TEST STAND FOR TESTING PROPERTIES OF AN ELECTRICALLY DRIVABLE AXLE MODULE FOR A MOTOR VEHICLE

(71) Applicant: ZF Friedrichshafen AG, Friedrichshafen (DE)

(72) Inventors: Christian Hell, Untergriesbach (DE); Thomas Dollinger, Passau (DE)

(73) Assignee: ZF Friedrichshafen AG, Friedrichshafen (DE)

(21) Appl. No.: 18/880,775

(22) PCT Filed: Jul. 10, 2023
(86) PCT No.: PCT/EP2023/069056

§ 371 Date: Jan. 2, 2025

(30) Foreign Application Priority Data
Jul. 11, 2022 (DE) 10 2022 207 056.9

(51) Int. Cl. G01M 13/025

(52) U.S. Cl. CPC G01M 13/025

(57) ABSTRACT

A test stand (100) for testing properties of an electrically drivable axle module (10) for a motor vehicle has at least one loading unit and at least one test object support (110) with a mechanical interface (120) for clamping the axle module (10), an electric interface (141) for energizing the axle module (10), a sensor interface (143) for contacting sensors of the axle module (10), and a fluid interface (142) for supplying fluid to the axle module (10). The mechanical interface (120) is designed as an interchangeable test object receiving area (120) onto which the axle module (10) is deposited over defined contact points (11).

### RELATED APPLICATIONS

This application claims the benefit under 35 U.S.C. § 371 as a U.S. National Phase Application of application no. PCT/EP2023/069056, filed on 10 Jul. 2023, which claims the benefit of German Patent Application no. 10 2022 207 056.9 filed on 11 Jul. 2022, the contents of which are hereby incorporated herein by reference in their entireties.

### FIELD OF THE DISCLOSURE

The invention relates to a test stand for testing the properties of an electrically drivable axle module for a motor vehicle.

### BACKGROUND

Transmission test stands or powertrain test stands for testing motor vehicle transmissions or complete motor vehicle powertrains are known from the prior art. These types of test stands are typically used for quality control to detect functional failures in powertrains at an early stage by subjecting them to a series of stress tests. Typical malfunctions are caused, for example, by components subject to backlash, such as gear wheels, synchronizer rings, synchronizer bodies, multi-plate clutch discs, and shafts, which can be deflected and excited to vibrate. As a rule, the acoustic behavior and the switching quality are also tested as part of such a quality control. In addition, test stands of this kind are also used in the development and continuous improvement of motor vehicle powertrains.

In this context, DE 103 28 461 A1 describes a vehicle test stand with a loading machine for each drivable wheel of a motor vehicle. The loading machines are connected directly to the rims of the vehicle wheels, for example via wheel bolts, or indirectly, for example via a belt drive, so that the load machines can both drive and brake the drive train. The vehicle test stand of DE 103 28 461 A1 also includes a frame construction, by means of which the motor vehicle and the loading machines can be raised and aligned with each other. During the test procedure, the motor vehicle is held completely over the frame construction so that the vehicle wheels have no contact with the ground.

### SUMMARY

From the as yet unpublished DE 10 2022 202 300.5 of the applicant, an “end-of-line” test stand is known, which is used to subject an electric axle drive to a function test directly after its assembly. For this purpose, the electric axle drive is placed on the test stand and the two output shafts of the axle drive are automatically connected to two test stand shafts, each of which is in a drive connection with a test stand loading motor.

However, the known motor vehicle test stands are disadvantageous in that the clamping of the test object in the test stand is comparatively complex and lengthy and usually also requires an adaptation, in particular of the mechanical interfaces of the test stand, to a specific type of test object or drive system.

The purpose of the present invention is to propose an improved test stand for testing the properties of an electrically drivable axle module for a motor vehicle.

This problem is solved by the test stand for testing the properties of an electrically drivable axle module for a motor vehicle according to the present disclosure. Advantageous designs and embodiments will be apparent from the present disclosure.

The invention relates to a test stand for testing the properties of an electrically drivable axle module for a motor vehicle, comprising at least one loading unit and at least one test object support with a mechanical interface for clamping the axle module, an electrical interface for energizing the axle module, a sensor interface for contacting sensors of the axle module, and a fluid interface for supplying the axle module with fluids. The test stand according to the invention is characterized in that the mechanical interface is designed as an interchangeable test object receiving area on which the axle module can be placed via defined contact points.

The invention describes a test stand that is suitable for testing the properties of an electrically drivable axle module for a motor vehicle. The properties that can be tested using the test stand are preferably mechanical properties and acoustic properties under various mechanical loads on the axle module, wherein the loads can be specified by the at least one loading unit.

The electrically drivable axle module is designed for operation in a motor vehicle, preferably in a passenger car. The axle module has an electric drive motor, a reduction gear, in particular a switchable reduction gear, and at least one output shaft. The axle module also preferably has two output shafts, wherein each of the two output shafts represents a wheel shaft of the axle.

The test stand according to the invention also includes at least one loading unit and at least one test object support. The at least one loading unit is advantageously at least one electric motor. Electric motors are comparatively compact, have a wide speed range, especially in comparison to combustion engines, and have the advantage of a largely maximum torque over a wide speed range.

It is advantageous to provide one loading unit for each output shaft of the axle module, so that the test stand will usually have two loading units.

The at least one loading unit has a motor shaft that can be connected to an output shaft of the axle module. Thus, the axle module can be subjected to at least one loading unit with pre-settable torques and speeds. The torque and the speed together represent a mechanical power with which the axle module can be loaded; in other words, the mechanical load on the axle module At the same time, the electric motor of the axle module can also generate a pre-settable speed and torque, which, for example, can be counteracted by the speed and torque of the at least one loading unit.

The test object support is used to receive the axle module to be tested, which, in the sense of the invention, represents the test object to be tested. The test object support is required to clamp the axle module as rigidly as possible in the test stand and at the same time to supply it with the means and media required to operate the axle module in the test stand.

For this purpose, the test object support first has a mechanical interface for clamping the axle module. In the context of the invention, the term “clamping” refers to the connection of the axle module to the test stand, which should be as rigid as possible so that no vibrations that could interfere with the test operation occur during the test operation. The mechanical interface is adapted to the specific geometry of the axle module so that the axle module can be clamped at the contact points intended for testing. These contact points can, for example, be those positions on a housing of the axle module that the axle module is clamped to in a motor vehicle, even when it is installed in a motor vehicle.

The specification of certain contact points on the axle module, for example by the manufacturer of the axle module, is important because not every point on the surface of the axle module is suitable for clamping the axle module. On the one hand, the axle module must be able to be held securely at a contact point, without slipping off an inclined surface, for example, and on the other hand, the contact point must also be designed to absorb the forces and torques with which the axle module is loaded, without being damaged or deformed by them.

Furthermore, the test object support has an electrical interface for energizing the axle module or the electric motor of the axle module. The electrical interface can, for example, be designed as one or more electrical sockets or plugs that make it possible to establish an electrical connection to the electric drive motor of the axle module or to its control electronics. This allows the electric drive motor of the axle module to be energized and operated for the test.

Furthermore, the test object support also has a sensor interface for contacting sensors of the axle module. This may be, for example, one or more temperature sensors, one or more position sensors to determine the rotor position of the drive motor, one or more current sensors, one or more voltage sensors, one or more speed sensors, and one or more torque sensors. The sensor interface is preferably designed as a series of plugs and sockets that make it possible to establish an electrical connection to the corresponding sensors of the axle module.

In addition, the sensor interface can also be designed to contact one or more acoustic sensors or structure-borne sound sensors, wherein the acoustic sensors or structure-borne sound sensors can also be assigned to the test stand and do not have to be components of the axle module. For example, acoustic sensors or structure-borne sound sensors can be placed on the axle module to monitor its acoustic properties.

Finally, the test object support has a fluid interface for supplying the axle module with fluid. The fluid can be a lubricant or coolant, for example. The fluid interface is therefore advantageously designed as one or more hydraulic couplings.

The test object support can be removed from the test stand, so that the axle module can be arranged on the test object support outside of the test stand- and thus comparatively easier. The axle module is then positioned for the test procedure together with the test object support at a designated position in the test stand, namely the test position.

Since the test object support can be conveniently removed from the test stand, the electrical interface, the sensor interface, and the fluid interface of the test object support are conveniently designed on the one hand as an interface for contacting the axle module, but at the same time also for contacting the test stand. This means that the interfaces can, for example, be connected to the axle module on the test object support when the axle module is being arranged. When the test position is reached on the test stand, the interfaces can also be connected to the corresponding connections on the test stand immediately before the test procedure. In other words, the electrical interface, the sensor interface, and the fluid interface connect the test stand supply lines with the axle module connections.

According to the invention, it is now planned that the mechanical interface is designed as an interchangeable test object receiving area on which the axle module is deposited via defined contact points.

This means, first of all that the mechanical interface is not—as is usually the case in the prior art—a fixed component of the test object support, but can be interchangeable, i.e., it can be replaced with other mechanical interfaces. Thus, depending on the axle module to be tested, only the mechanical interface of the test object support can be changed comparatively quickly, easily, and above all, cost-effectively, so that the test object support can be converted to receive axle modules of very different designs. This means that it is not necessary to have a plurality of different and comparatively expensive test object supports, but only a corresponding number of interchangeable mechanical interfaces. The test object support itself can be easily adapted to a plurality of different axle drives.

By depositing the axle module only on the test object receiving area, namely via the contact points, the arrangement and assembly of the axle module on the test object support or on the test object receiving area is simplified compared to the prior art, since it is common in the prior art to clamp the axle module firmly to the test object support when mounting it on the test object support. However, this clamping is not necessary if the axial module is arranged on the test object support, as is the case with the invention, so that the assembly and installation on the test object support is simplified and accelerated. In other words, the test object support or the mechanical interface forms only one “position nest” in which or on which the axle module to be tested is deposited.

The test object receiving area can be conveniently connected to the test object support using a standardized connection, for example a screw connection or a clamp connection.

According to a preferred embodiment of the invention, it is envisaged that the test stand includes a conveyor belt that is designed to automatically drive the test object support into a test position in the test stand. The conveyor belt can be designed in particular as a roller conveyor belt.

The advantage of this is that the test object support with the axle module arranged on it can simply be deposited on the conveyor belt and then moved into the test position automatically and without further human intervention by means of the conveyor belt. The test object support with the axle module is also automatically retracted from the test position after the test procedure has been completed, so that the next test object support, together with the axle module arranged on it, can be moved into the test position.

According to a particularly preferred embodiment of the invention, it is envisaged that the test stand also includes an interchangeable clamping receiving area that can be moved along an axle and is designed to clamp the axle module to the test object receiving area in an automated manner when the test position is reached. The axle module is advantageously clamped at the defined contact points.

The preferred axle is a vertical axle so that the clamping receiving area can be moved from above onto the axle module on the test object receiving area.

Alternatively, it can also be a horizontal axle, so that the axle module is clamped from the side accordingly. In this case, the test object receiving area can also have a lateral support for the axle module.

This has the advantage that the clamping of the axle module can also be automated and carried out relatively quickly without human intervention.

The clamping receiving area is a counterpart to the interchangeable test object receiving area and, like the test object receiving area, can be interchangeable to allow a plurality of different axle modules to be tested. The clamping receiving area is also customized for the axle module to be tested.

In contrast to the test object receiving area, however, the clamping receiving area is not arranged on the test object support or is not an interchangeable component of the test object support, but is arranged on the test stand, namely vertically movable or movable above the test object support.

When the axle module reaches the test position on the test object receiving area or on the test object support, for example by means of the conveyor belt, then the clamping receiving area is advantageously moved vertically downwards in an automated manner in order to clamp the axle module between the test object receiving area and the clamping receiving area at the contact points. The axle module is now clamped in the test stand and can be subjected to the test procedure.

As it turned out, clamping the axle module between the test object receiving area and the clamping receiving area provides a sufficiently rigid connection to also enable test procedures at high speeds without the test procedure being adversely affected by mechanical vibrations. For example, axle modules can be tested in this way whose electric drive motor can provide speeds of more than 18,000 rpm.

According to a particularly preferred embodiment of the invention, it is envisaged that the test stand is designed to automatically contact the electrical interface, the sensor interface, and the fluid interface when the test position is reached. This means that the axle module can be subjected to the test procedure relatively quickly and efficiently without further human intervention.

According to a very preferred embodiment of the invention, the electrical interface, the sensor interface, and the fluid interface are formed as a common multi-coupling. A multi-coupling is a coupling that connects interfaces of different types, such as power supply, fluid, and sensor connections, for a common contact in a common coupling. The mentioned interfaces are preferably positioned in a defined arrangement within the coupling to each other, so that a coupling counterpart, which has a mirror-image positioning of the interfaces, can contact the coupling and also contact all interfaces simultaneously. Instead of having to contact each interface individually, all three interfaces can be contacted at once via the multi-coupling. This reduces the time needed to prepare the axle module for the test procedure.

According to another very preferred embodiment of the invention, the electrical interface, the sensor interface, and the fluid interface are contacted in a vertical movement Accordingly, the multi-coupling is also advantageously contacted in the vertical movement Since the test stand for the vertical movement of the clamping receiving area must have a device for vertical adjustability anyway, for example a hydraulic cylinder or an electrically adjustable threaded spindle that moves a support, the electrical interface, the sensor interface, and the fluid interface or the multi-coupling can also be contacted via the device for vertical adjustability.

According to another very preferred embodiment of the invention, the test stand is configured to vertically move the multi-coupling and the clamping receiving area in a common vertical movement in order to close the multi-coupling and clamp the axle module. This means that no separate means of vertical adjustment of the multi-coupling and the vertical adjustment of the clamping receiving area have to be provided This causes the multi-coupling and the clamping receiving area to move vertically at the same time, thus accelerating the testing process.

According to a further preferred embodiment of the invention, it is envisaged that the test object support has interchangeable supply lines extending from the electrical interface, the sensor interface, and the fluid interface for making electrical, sensor, and fluidic contact with the axle module. Since the supply lines can be changed, they can be interchangeable as needed. analogous to the test object receiving areas and clamping receiving areas, and adapted to the axle module to be tested.

The supply lines are advantageously designed as cables, wires, or hoses. The supply lines advantageously have a standardized connection, for example a socket or plug, at a first end, which is intended for connection to the electrical interface, the sensor interface, and the fluid interface. At their other end, however, which is intended for connection to a corresponding connection of the axle module, the supply lines have a connection that is specifically adapted to the axle module, for example a specific plug or a specific socket Thus, the axle module can be connected to the interfaces of the test object support by selecting the appropriate supply lines, without the need for a completely different test object support adapted to the axle module.

According to a particularly preferred embodiment of the invention, it is envisaged that the supply lines are automatically connected to the axle module when the test position is reached. This can be done advantageously using one or more robot arms, which can be an integral part of the test stand. This means that the supply lines can also be connected to the axle module without human intervention, which in turn reduces the preparation time for the actual test procedure.

According to a further preferred embodiment of the invention, it is envisaged that the test stand has a clamping receiving area magazine for storing a plurality of different interchangeable clamping receiving areas, wherein the test stand is designed to change the clamping receiving areas automatically. The clamping receiving area magazine can, for example, store clamping receiving areas for the types of axle modules that are usually tested using the test stand. The type of axle module to be tested next can then be specified by the operator, for example on a PC or control unit assigned to the test stand, whereupon the test stand automatically selects a corresponding clamping frame from the clamping receiving area magazine.

In particular, the clamping receiving area magazine can be designed as a guide or rod on which a plurality of different clamping receiving areas are arranged in a slidable manner. A clamping receiving area can then be positioned above the axle module to be tested in the test position.

Alternatively, different clamping receiving areas can be selected by means of a robot arm, removed from a storage location and arranged on the test stand.

According to a particularly preferred embodiment of the invention, it is envisaged that the test stand has a support plate for the test object support in the area of the test position, wherein the conveyor belt is arranged above the support plate and having a recess for the support plate, wherein the test object support is longer and/or wider than the recess, wherein the conveyor belt has a spring suspension and wherein the test stand is designed to press the test object support onto the support plate by means of the clamping receiving area against the spring suspension.

The test stand therefore has a support plate on which the test object support can in principle rest. This support plate is arranged in the area of the test position below the test object support. Since the test object support initially rests on the conveyor belt, the conveyor belt is arranged in a vertical direction between the test object support and the support plate. Accordingly, the conveyor belt must have a recess through which the test object support can be brought into contact with the support plate. The conveyor belt is held horizontally in the area of the test position by a spring suspension. By applying a vertical force to the axle module preferably by clamping the axle module between the test object receiving area and the clamping receiving area that is vertically adjusted to the axle module-a force is also applied to the conveyor belt and against the spring suspension. This force is dimensioned in such a way that it presses the axle module and the conveyor belt downwards against the spring suspension until the support plate protrudes from below through the recess of the conveyor belt and comes into contact with the test object support from below.

The support plate is preferably made of cast concrete or mineral concrete.

Thus, the test object is connected to the test stand in a comparatively rigid manner and can be subjected to the test process even at high and very high speeds, without disturbing vibrations occurring during the test process.

According to a further preferred embodiment of the invention, it is envisaged that the test stand for producing a drive connection between a loading unit and an output shaft of the axle module has an adapter shaft magazine for storing a plurality of different interchangeable adapter shafts, wherein the test stand is designed to change the adapter shafts automatically. The adapter shafts are used to establish a drive connection between a loading unit and an output shaft of the axle module by connecting the motor shafts of the loading units to the output shafts of the axle module in a rotationally fixed manner. One end of each adapter shaft has a standardized connection, for example a plug connection, in order to be able to connect the adapter shaft to a motor shaft of the respective loading unit in a rotationally fixed manner. A second end of the adapter shafts, on the other hand, is specifically adapted to the type of axle module to be tested. The test stand can be used to test a plurality of different types of axle modules because the adapter shaft magazine is designed to store a plurality of different interchangeable adapter shafts. The adapter shafts can be changed automatically by a robot arm, for example, in accordance with an operator input via the PC or the control unit. This means that the test stand can also be adapted relatively quickly and easily to the different output shafts of different types of axle modules.

According to a further preferred embodiment of the invention, it is envisaged that the at least one test object support has at least one centering element, wherein the test stand is designed to automatically align the at least one test object support when the at least one centering element reaches the test position. The centering element can be designed, for example, as a pin or a hole.

The test object support has two centering elements.

The centering elements allow the test object support to be precisely aligned in the test position as required for automated contacting of both the multi-coupling and the output shafts of the axle module.

Centering itself is preferably achieved by bringing the centering element into engagement with a counter-element, for example a bore, in contact with a pin, in particular a conical pin, and thereby aligning it.

The intervention of a human operator is therefore not required.

### BRIEF DESCRIPTION OF THE DRAWINGS

The invention is explained below by way of examples of embodiments shown in the figures.

The following are shown:

FIG. 1 is an example of a schematic structure of a test stand according to the invention for testing the properties of an electrically drivable axle module for a motor vehicle,

FIG. 2 shows the test stand in FIG. 1, but with a clamped axle module,

FIG. 3 also shows the test stand from FIG. 1, but in a side view,

FIG. 4 shows the test stand of FIG. 1 in the side view of FIG. 3, but with a clamped axle module,

FIG. 5 is an example of another possible design for a test stand according to the invention,

FIG. 6 is an example of a possible training form for a section of a test stand according to the invention,

FIG. 7 shows an example and a schematic representation of a possible form of training of a test object support,

FIG. 8 is an example of another possible design for a test stand according to the invention, and

FIG. 9 is an example of another possible design for a test stand according to the invention.

### DETAILED DESCRIPTION

Identical objects, functional units, and comparable components are designated with the same reference signs across all figures. These objects, functional units, and comparable components are designed identically with regard to their technical features, unless explicitly or implicitly stated otherwise in the description.

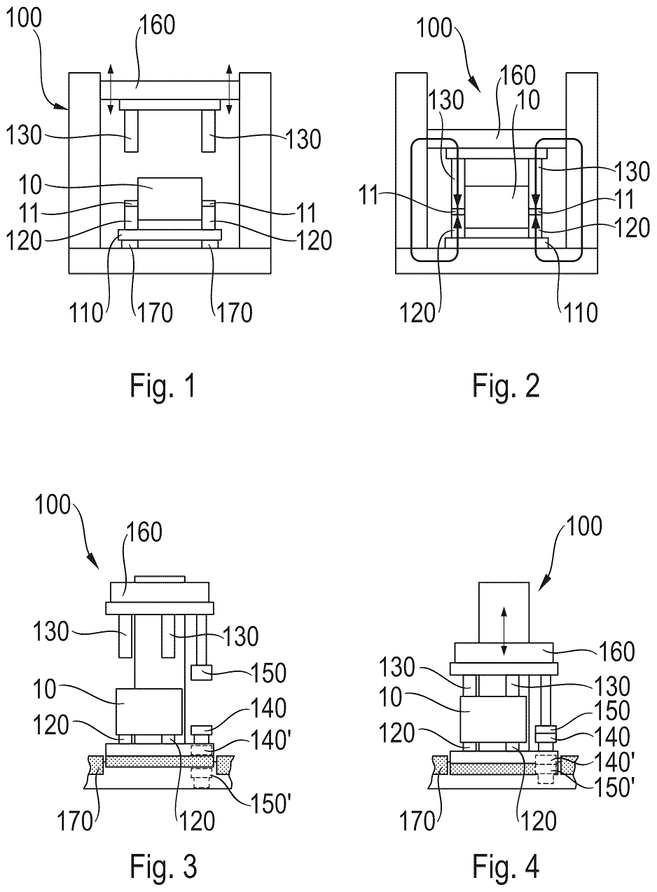

FIG. 1 shows an example of a test stand 100 according to the invention for testing the properties of an electrically drivable axle module 10 for a motor vehicle (not shown in FIG. 1) in a view from the front. The test stand includes, for example, two non-represented loading units, each of which is designed as an electric motor and whose motor shafts (also not shown in FIG. 1) are each connected in a rotationally fixed manner to the output shafts (also not shown in FIG. 1) of the axle module 10 via adapter shafts (also not shown in FIG. 1) designed for this purpose.

Furthermore, the test stand 100 of FIG. 1 includes a test object support 110, wherein the test object support 110 in turn includes a mechanical interface 120 for clamping the axle module 10, an electrical interface 141 for energizing the axle module 10, a sensor interface 143 for contacting sensors of the axle module 10, and a fluid interface 142 for supplying fluid to the axle module 10. For the sake of clarity, only the mechanical interface 120 is shown in FIG. 1.

As can be seen, the axle module 10 is deposited on the mechanical interface 120. which is designed as an interchangeable test object receiving area 120. The axle module 10 has a series of defined contact points 11 for this purpose. The test specimen receiving area 120 is adapted to the specific geometry of the axle module 10 so that the axle module 10 can be clamped at the contact points 11 intended for testing, or can first be deposited on the test specimen receiving area 120 by means of the contact points 11. The contact points 11 of the axle module 10 are, for example, the contact points 11 by means of which the axle module 10 is clamped in a motor vehicle when installed in a motor vehicle.

It can also be seen in FIG. 1 that the test stand 100 also comprises an interchangeable clamping receiving area 130 that can be moved along a vertical axle (shown by two arrows in FIG. 1). The clamping receiving area 130 is moved by the support 160. The clamping receiving area 130, like the test object receiving area 120, is designed to clamp the axle module 10 in the test stand 100, for example by clamping, in that the clamping receiving area 130 is moved vertically downwards from above to clamp the axle module 10 at the defined contact points 11.

When the axle module 10 has been placed on the test object receiving area 120 and the test object receiving area 120 has been placed on the test stand 100 with the test object support 110, the clamping receiving area 130 can be automatically moved downwards vertically to clamp the axle module 10.

Also shown in FIG. 1 is a conveyor belt 170, which is designed as an example of a roller conveyor belt 170. The conveyor belt 170 has a spring suspension 180, not shown in FIG. 1, below the conveyor belt 170, which pushes the conveyor belt 170 with the test object support 110 arranged on it and the test object receiving area 120 upwards.

Both the test object receiving area 120 and the clamping receiving area 130 are interchangeable, i.e., different test object receiving areas 120 can be arranged on the test object support 110, which are each adapted to different axle modules 10. It is therefore advantageous not to have to provide a plurality of comparatively expensive test object supports 110, each with a fixed mechanical interface 120, in order to be able to test different types of axle modules 10 on the test stand 100.

The clamping receiving area 130 can be interchangeable in the same way, so that different types of axle modules 10 can be clamped and tested in the test stand 100.

FIG. 2 shows the test stand 100 in FIG. 1, but with a clamped axle module 10. As can be seen, the support 160 with the clamping receiving area 130 has moved vertically downwards in order to clamp the axle module 10 between the clamping receiving area 130 and the test object receiving area 120 at the defined contact points Il provided for this purpose.

Since the clamping receiving area 130 was moved vertically downwards to clamp the axle module 10 in the test stand 100, a corresponding pressure acts from above on the spring suspension 180 of the conveyor belt 170, so that the conveyor belt is pressed vertically downwards against the spring force of the spring suspension 180 and rests from above on a support plate 190 not shown in FIG. 2. The ring-shaped arrows illustrate the flow of force for clamping the axle module 10 at the contact points 11 through the test object receiving area 110 and the clamping receiving area 130.

FIG. 3 also shows the test stand 100 from FIG. 1, but in a side view. In the side view of FIG. 3, in contrast to the frontal view of FIG. 1, an additional multi-coupling 140 can be seen, which is arranged on top of the test object support 110. The multi-coupling 140 combines the interfaces 141, 142, 143 for the power supply of the axle module 10 as well as for the fluid and sensor connection for a common contact. These interfaces 141, 142, 143 are positioned in a defined arrangement within the multi-coupling 140 in relation to one another so that a coupling counterpart 150, which has a mirror-image positioning of the interfaces 141, 142, 143 can contact the multi-coupling 140 so as to simultaneously connect all interfaces 141, 142, 143 in the multi-coupling 140.

As can be seen, the multi-coupling 140 is connected to the coupling counterpart 150 when the clamping receiving area 130 is moved vertically downwards, since the clamping receiving area 130 and the coupling counterpart 150 are arranged on the same support 160 of the test stand 100.

FIG. 3 shows a further possible arrangement of the multi-coupling 140′ in dashed lines. In this case, the multi-coupling 140′ is not arranged on top of the test object support 110, but at the bottom of the test object support 110. The associated coupling counterpart 150′ is also shown with a dashed line and is arranged below the conveyor belt 140. In this case, the multi-coupling 140′ is connected to the coupling counterpart 150′ when the clamping receiving area 130 exerts sufficient force on the axle module 10 and thus on the test object support 110 to move it against the spring of the spring suspension 180 (not shown in FIG. 3) of the conveyor belt 170 in the direction of the coupling counterpart 150′ and thus to connect the multi-coupling 140′ to the coupling counterpart 150′.

FIG. 4 shows the test stand 100 in FIG. 1 in the side view of FIG. 3, but with an axle module 10 clamped in it. In addition, in the figure, the multi-coupling 140 is connected to the coupling counterpart 150, and the alternative multi-coupling 140′ (shown with dashed lines) is connected to the coupling counterpart 150′.

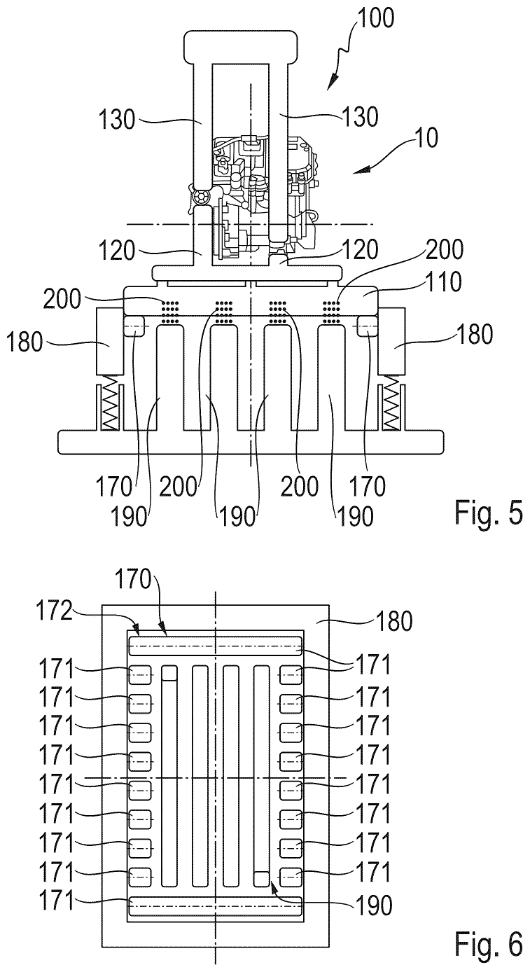

FIG. 5 shows an example of another possible design of a test stand 100 according to the invention for testing the properties of an electrically drivable axle module 10 for a motor vehicle (not shown in FIG. 5). FIG. 5 shows, in comparison to FIGS. 1 through 4, in particular the support plate 190, which consists of four ribs, each made of a mineral cast. At the upper ends of the ribs of the support plate 190, scrapers 200 are arranged, which, for example, are designed as brushes 200 to remove dirt from the underside of the test object support 110 when it is moved by the conveyor belt 170 over the support plate 190. It is also conceivable to design the scrapers 200 as rubber lips. If the support 160 (not shown in FIG. 5) now moves vertically downwards in order to move the clamping receiving area 130 downwards and clamp the axle module 10 in the test stand 100, a force also acts on the test object receiving area 120, the test object support 110, and the conveyor belt 170. This force pushes the conveyor belt 170 downwards against the spring force of the spring suspensions 180 until the test object support 110 rests on the support plate 190.

FIG. 6 shows an example and schematic of a possible design of a section of a test stand 100 according to the invention, namely the support plate 190, consisting of four ribs, as well as the conveyor belt 170 and the spring suspension 180 in a top view from above.

As can be seen, the conveyor belt 170, which is an example of a roller conveyor belt 170 with rollers 171, has a recess 172. The support plate 190 can be seen through the recess 172. The conveyor belt 170 is normally held in a position above the support plate 190 by the spring suspension 180. However, when subjected to a corresponding force acting vertically downwards, the conveyor belt 170 can be pushed downwards against the spring force of the spring suspension 180.

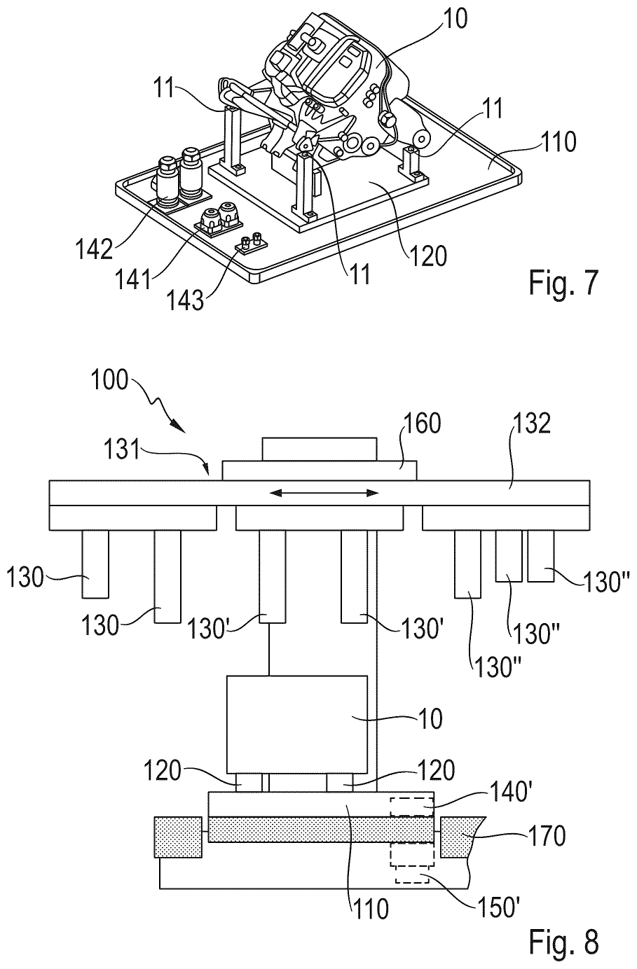

FIG. 7 shows an example of a possible design of a test object support 110 with a test object receiving area 120, an electrical interface 141, a fluid interface 142, and a sensor interface 143. As can be seen, each interface 141, 142, 143, for example, has two sockets, wherein a first socket of each interface 141, 142, 143 enables a supply of electrical current or electrical voltage or fluid to the axle module 10 and a second socket of each interface 141, 142, 143 enables a return. For this purpose, the first socket and the second socket of each interface 141, 142, 143 are connected to the corresponding connections of the axle module 10 by means of a suitable connecting means such as a suitable cable, a suitable hose, or a suitable wire with a suitably designed plug. The connecting means and the test object receiving area 120 are interchangeable, so that, depending on the axle module 10 to be tested, suitable connecting means 120 can be selected and connected to the first and second socket of the interfaces 141, 142, and 143. The axle module 10 rests on the test object receiving area 120 with the contact points 11.

For example, the interfaces 141, 142, 143 represent a multi-coupling 140, which can be contacted by a corresponding coupling counterpart 150′ from below through the test stand 100 in order to enable an electrical supply or fluid supply or sensor signal connection for the axle module 10 via the interfaces 141, 142, 143.

FIG. 8 shows an example of another possible design of a test stand 100 for testing the properties of an electrically drivable axle module 10 for a motor vehicle (not shown in FIG. 8).

The test stand of FIG. 8 has a multi-coupling 140′ that can be contacted from below by means of a coupling counterpart 150′. In addition, the test stand 100 has a clamping receiving area magazine 131 for storing three different interchangeable clamping receiving areas 130, 130′, 130″, wherein the test stand 100 is designed to automatically change the clamping receiving areas 130, 130′, 130″. For automated changing of the clamping receiving areas 130, 130′ 130″, these can be moved laterally along the platform 132, so that the required clamping receiving area 130, 130′ 130″ that matches an axle module 10 can be positioned above the axle module and thus used for the test procedure.

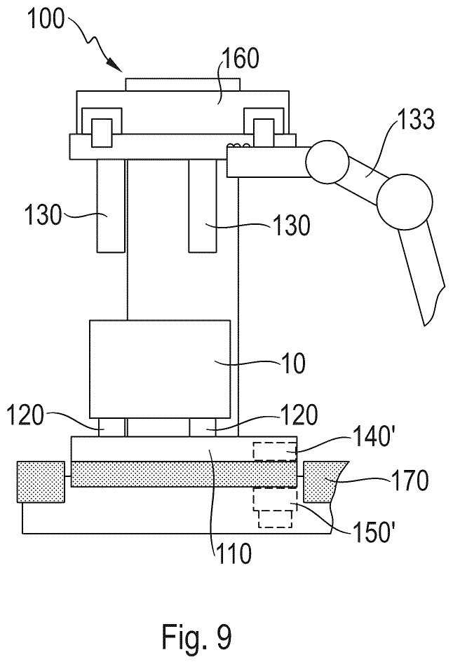

FIG. 9 shows an example of another possible design of a test stand 100 for testing the properties of an electrically drivable axle module 10 for a motor vehicle (not shown in FIG. 9).

The test stand 100 in FIG. 9 differs from the test stand 100 in FIG. 8 in the way the clamping receiving area magazine 131 is formed (not shown in FIG. 9). In contrast to the test stand 100 of FIG. 8, the test stand 100 of FIG. 9 has a robot arm 133 that removes the different clamping receiving areas 130, 130′, 130″ from the clamping receiving area magazine 131 and arranges them on the support 160.

### LIST OF REFERENCE NUMERALS

10 Axle module
11 Contact point
100 Test stand
110 Test object support
120 Test object receiving area, mechanical interface
130 Clamping receiving area
130′ Clamping receiving area
130″ Clamping receiving area
130′″ Clamping receiving area
131 Clamping receiving area magazine
132 Platform
133 Robot arm
140 Multi-coupling
140′ Multi-coupling
141 Electrical interface
142 Fluid interface
143 Sensor interface
150 Coupling counterpart
150 Coupling counterpart
160 Support
170 Conveyor belt, roller conveyor belt
171 Rollers
172 Recess
180 Spring suspension
190 Support plate
200 Scraper, brush, rubber lip

1. A test stand (100) for testing properties of an electrically drivable axle module (10) for a motor vehicle, the test stand comprising:
at least one loading unit;
at least one test object support (110) with a mechanical interface (120) for clamping the axle module (10), wherein the mechanical interface (120) is configured as an interchangeable test object receiving area (120) onto which the axle module (10) can be placed via defined contact points (11);
an electric interface (141) for energizing the axle module (10);
a sensor interface (143) for contacting sensors of the axle module (10); and
a fluid interface (142) for supplying fluid to the axle module (10).

2. The test stand (100) according to claim 1, comprising a conveyor belt (170) configured to automatically transport the test object support (110) to a test position in the test stand (100).

3. The test stand according to claim 2, comprising an interchangeable clamping receiving area (130, 130′, 130″) which can be moved along an axle and is configuredto automatically clamp the axle module (10) on the test object receiving area (120) when the test position is reached.

4. The test stand (100) according to claim 2, wherein the test stand (100) is designed to automatically contact the electrical interface (141), the sensor interface (143), and the fluid interface when the test position is reached.

5. The test stand (100) according to claim 4,
wherein the electrical interface (141), the sensor interface (143), and the fluid interface (142) are configured as a common multi-coupling (140, 140′).

6. The test stand (100) according to claim 5, wherein the electrical interface (141), the sensor interface (143), and the fluid interface are contacted in a vertical movement.

7. The test stand (100) according to claim 6, wherein the test stand is configured to vertically move the multi-coupling (140) and the clamping receiving area (130) in a common vertical movement in order to close the multi-coupling (140) and to clamp the axle module (10).

8. The test stand according to claim 1, wherein the test object support (110) has interchangeable supply lines, which emanate from the electrical interface (141), the sensor interface (143), and the fluid interface (142), for making electrical, sensor, and fluid contact with the axle module.

9. The test stand (100) according to claim 8,
wherein the supply lines are automatically connected to the axle module (10) when the test position is reached.

10. The test stand according to claim 1, comprising:
a clamping receiving area magazine configured for storing a plurality of different interchangeable clamping receiving areas (130, 130′, 130″), wherein the test stand (100) is configured to change the clamping receiving areas (130, 130′, 130″) in an automated manner.

11. The test stand (100) according to claim 10, comprising:
a support plate (190) for the test object support (110) in the area of the test position,
wherein the conveyor belt (170) is arranged above the support plate (190) and defines a recess (172) for the support plate (190),
wherein the test object support (110) is longer and/or wider than the recess (190),
wherein the conveyor belt (170) has a spring suspension (180), and
wherein the test stand (100) is configured to press the test object support (110) onto the support plate (190) by means of the clamping receiving area (130, 130′, 130″) against the spring suspension (180).

12. The test stand (100) according to claim 1, comprising:
an adapter shaft magazine configured for producing a drive connection between a respective loading unit and a respective output shaft of the axle module (10); and
an adapter shaft magazine configured for storing a plurality of different interchangeable adapter shafts,
wherein the test stand (100) is configured to change the adapter shafts in an automated manner.

13. The test stand (100) according to claim 1, wherein the at least one test object support (110) has at least one centering element, wherein the test stand (100) is configured to automatically align the at least one test object support (110) when it reaches the test position by means of the at least one centering element.
